(19) United States
(12) Patent Application Publication
(10) Pub. No.: US 2016/0290064 A1
(43) Pub. Date: Oct. 6, 2016

(54) WIRE-HARNESS-LESS INSERT ASSEMBLY MECHANISM

(71) Applicant: HALLIBURTON ENERGY SERVICES, INC., Houston, TX (US)

(72) Inventors: Rex Dael Navarro, Singapore (SG); Philbert Pasco Perez, Singapore (SG); Shijie Ong, Singapore (SG); Williem Wong, Singapore (SG)

(73) Assignee: Halliburton Energy Services, Inc., Houston, TX (US)

(21) Appl. No.: 15/037,599

(22) PCT Filed: Dec. 18, 2013
(86) PCT No.: PCT/US2013/075999

§ 371 Date: May 18, 2016

(51) Int. Cl. E21B 17/02; H01R 27/02; H01R 12/72; E21B 49/00; H01R 12/71

(52) U.S. Cl. CPC E21B 17/028; E21B 49/00; H01R 12/716; H01R 12/722; H01R 27/02; E21B 47/024

(57) ABSTRACT

A method and apparatus for electronically coupling electronics in downhole tools without a harness is described. The apparatus includes one or more electronics boards, which may be disposed around a tool insert and electronically coupled using a backplane. The backplane may comprise one or more backplane segments, and each of the segments may comprise two printed circuit boards communicatively coupled to each other. The two printed circuit boards may be on opposite sides of a base metal ring and may be coupled to each other via connectors in a cavity of the base metal ring. Dampers may be placed between the base metal ring and each of the printed circuit boards. The printed circuit boards my optionally include an identification chip for storing information concerning the electronics boards coupled to the backplane. Additionally or alternatively, the printed circuit boards may optionally include active device chips that dynamically route signals based on which electronics boards are coupled to the backplane.

### BACKGROUND

The present disclosure relates generally to oil field exploration and, more particularly, to a system and method for electronically coupling electronics in downhole tools without a harness.

The use of downhole tools is well known in the subterranean well drilling and completion art. Those tools include electronics inserts, which typically are electronically interconnected using wires that may be bundled together in a harness. The wire harnesses may use pin and socket type connectors and may be secured via adhesive tape and cable ties. The wires are of fixed/static configuration and must be manually reconnected if tool configurations are changed. Further, the wires may cause noise and interference that potentially degrades tool performance.

### FIGURES

Some specific exemplary embodiments of the disclosure may be understood by referring, in part, to the following description and the accompanying drawings.

FIGS. 1A-B illustrate an embodiment of a wire-harnessless assembly mechanism.

FIGS. 2A-B illustrate an embodiment of a backplane PCB segment.

FIGS. 3A-C illustrate example embodiments of backplane PCBs for various configurations of a tool insert.

FIG. 4 illustrates an exploded view of an embodiment of a wire-harness-less assembly mechanism.

FIG. 5 illustrates a cross-section of an example embodiment of a wire-harness-less assembly mechanism.

FIG. 6A-B are diagrams respectively showing illustrative logging-while-drilling and wireline-logging environments.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to oil field exploration and, more particularly, to a system and method for electronically coupling electronics in downhole tools without a harness.

Illustrative embodiments of the present disclosure are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the disclosure. Embodiments of the present disclosure may be applicable to horizontal, vertical, deviated, multilateral, u-tube connection, intersection, bypass (drill around a mid-depth stuck fish and back into the well below), or otherwise nonlinear wellbores in any type of subterranean formation. Embodiments may be applicable to injection wells, and production wells, including natural resource production wells such as hydrogen sulfide, hydrocarbons or geothermal wells; as well as borehole construction for river crossing tunneling and other such tunneling boreholes for near surface construction purposes or borehole u-tube pipelines used for the transportation of fluids such as hydrocarbons. Devices and methods in accordance with embodiments described herein may be used in one or more of measurement-while-drilling (“MWD”) and logging-while-drilling (“LWD”) operations. Embodiments described below with respect to one implementation are not intended to be limiting.

The terms “couple” or “couples” as used herein are intended to mean either an indirect or a direct connection. Thus, if a first device couples to a second device, that connection may be through a direct connection or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections.

The present disclosure describes a system and means for interconnecting electronics modules in downhole tools using a backplane, an apparatus that communicatively couples electronics modules together. The backplane may include two or more connectors (such as sockets), where communication points in one connector (such as pins) may be communicatively coupled to communication points in another connector. Electric circuits plugged into one connector may thereby be coupled to electrical circuits plugged into another connector. The communicative coupling between communications points may be accomplished using wires. In one or more embodiments, the backplane may be a printed circuit board (PCB) where communicative couplings are formed by etched copper conductive paths. In passive backplanes, the selection and routing of conductive paths between connectors may be fixed; in active backplanes, circuitry may be included for dynamic selection and routing of the conductive paths between connectors.

The electronics modules to be interconnected using the backplane may include electronics boards, power sources, sensors, and other electronic/electrical modules known to those of skill in the art. The backplane PCB may provide improved interconnection between such electronics modules. Unlike wire harnesses, which must be manually reconfigured based on the specific electronics modules used, backplane PCBs may contain universal connectors and dynamically route signals based on the connected electronics modules. Additionally, backplane PCBs may be reprogrammable and may support features not possible in wire harnesses, such as electronic inventory management schemes and high-speed optical interconnections.

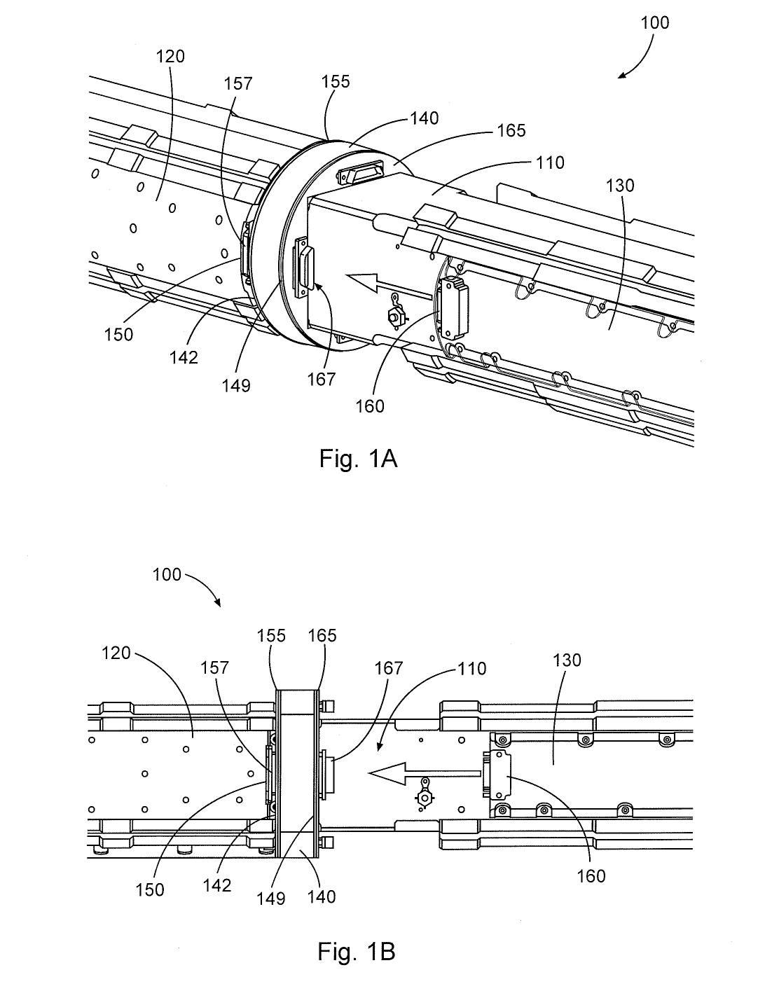

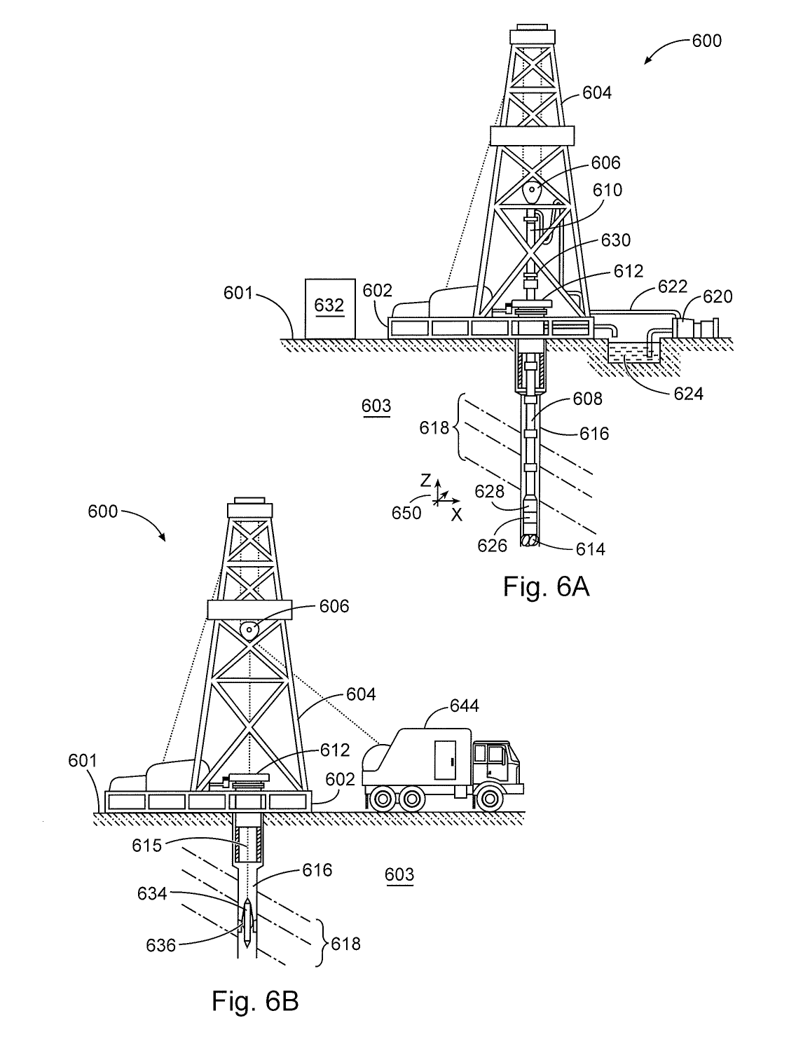

FIGS. 1A-B are diagrams illustrating an embodiment of a wire-harness-less assembly mechanism for a downhole tool assembly 100, such as may be incorporated in an LWD/MWD apparatus as shown below in FIG. 6A, a wireline conveyed apparatus as shown below in FIG. 6B, or similar apparatuses (e.g. conveyed by coiled tubing, slickline, tractor, etc.).

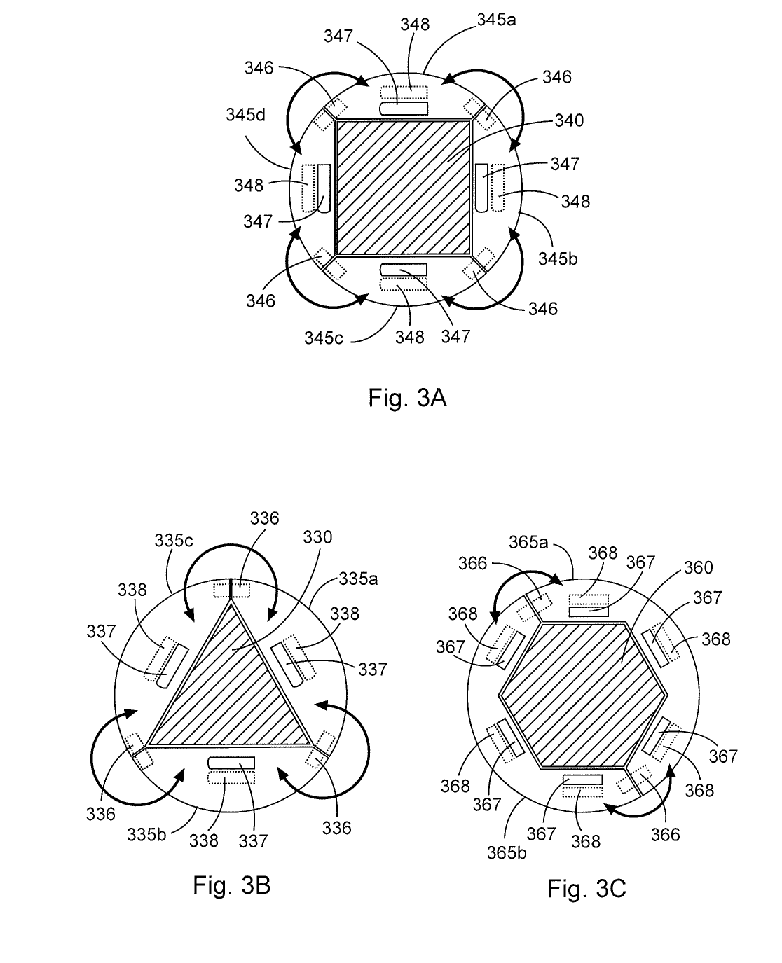

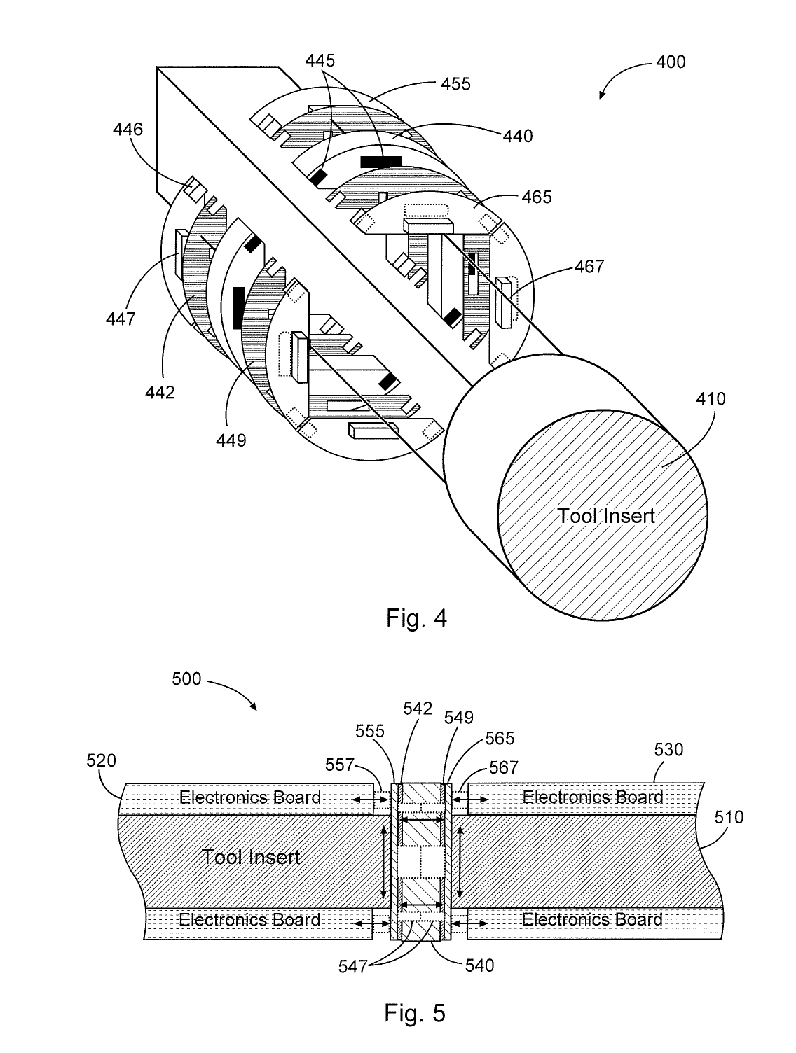

Downhole tool assembly 100 may include a tool insert 110, electronics modules 120 and 130, and base metal ring 140. Electronics modules 120 and 130 may be arrayed around the exterior of tool insert 110. Tool insert 110 may be a rigid structure to which electronics modules may be mounted. Although in FIGS. 1A-B, tool insert 110 is shown as having an approximately 4-face cross section, in alternative configurations, a tool insert may have 3-face or 6-face cross-sections, as shown in FIGS. 3A-C. Although not shown, those of skill in the art in light of this disclosure will understand that it may also have circular cross sections, or other polygonal, symmetrical, or asymmetrical cross sections. A tool insert may optionally be configured to provide power or telemetry to mounted electronics modules. A base metal ring 140 may be disposed between electronics modules 120 and 130. The base metal ring 140 may have base metal ring cavities—as will be discussed with respect to FIG. 4 but which are not visible in FIGS. 1A-B—that may facilitate electrical coupling from one side of the base metal ring to another.

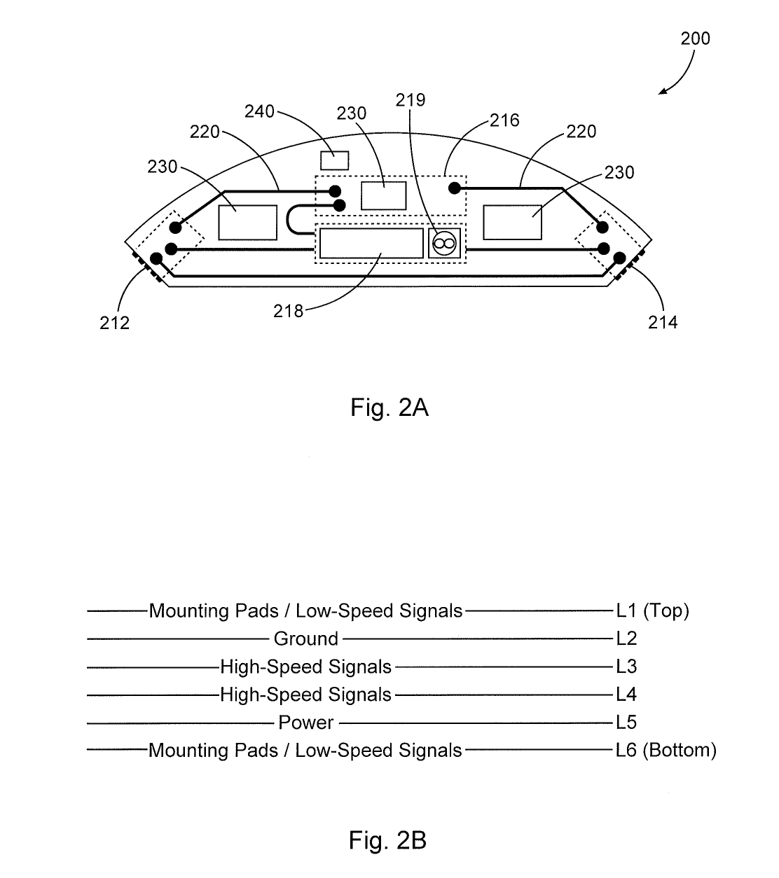

The interconnection of the electronics modules 120 and 130 in the embodiment of FIGS. 1A-B may be accomplished using backplane PCBs, according to the present disclosure. FIGS. 1A-B show two backplane PCBs 155 and 165 disposed proximate to tool insert 110. In the embodiment of FIG. 1A, backplane PCB 155 is shown comprised of four backplane PCB segments, and a backplane PCB 165 is shown comprised of four backplane segments. Although not visible in FIGS. 1A-B, the individual backplane PCB segments of backplane PCB 155 may be communicatively coupled by means of same-side backplane connectors; similarly, individual backplane PCB segments of backplane PCB 165 may be communicatively coupled by means of same-side backplane connectors. Same-side backplane connectors are discussed below with respect to FIGS. 2A-B. Backplane PCBs 155 and 165 may be arrayed proximate to base metal ring 140. Although not visible in FIGS. 1A-B, the backplane PCBs 155 and 165 may be communicatively coupled via opposite-side backplane connectors, as will be discussed below with respect to FIG. 4.

The backplane PCBs 155 and 165 may include connectors to interface with similar connectors on electronics modules 120 and 130. Specifically, backplane PCBs 155 and 165 may include backplane-to-electronics-module connectors 157 and 167, respectively, which are configured to interconnect with PCB connectors 150 and 160, located on electronics modules 120 and 130, respectively.

In FIGS. 1A-B, electronics module 120 is shown as electronically coupled to backplane PCB 155 via PCB connector 150 and backplane-to-electronics-module connector 157. When electronics module 120 is electronically coupled, it may be referred to as in a secured or mounted state. By comparison, electronics module 130 is shown as not electronically coupled to backplane PCB 165 and may be referred to as in an unsecured or unmounted state. If both electronics modules 120 and 130 were in a mounted state, an electronic communication path would exist from electronic module 120 through PCB connector 150, backplane-to-electronics-module connector 157, backplane PCBs 155 and 165, backplane-to-electronics-module connector 167, PCB connector 160, and finally to electronics module 130.

In the embodiment of FIGS. 1A-B, optional insulator/dampers 142 and 149 are shown disposed between base metal ring 140 and backplane PCBs 155 and 165. Insulator/dampers 142 and 149 may be made of non-conductive material to prevent electronic signals from backplane PCBs 155 and 165 from shorting against base metal ring 140. Alternatively or in addition, insulator/dampers 142 and 149 may be made of vibration-absorbing material that provides resilience to backplane PCBs 155 and 165—as well as PCB connectors 150 and 160, and backplane-to-electronics-module connectors 157 and 167—in the hostile downhole environment.

FIGS. 2A-B illustrates an exemplary embodiment of a backplane PCB segment 200, such as the backplane PCB segments that compose backplane PCBs 155 and 165 in FIG. 1. FIG. 2A depicts the exterior of a backplane PCB segment 200. As shown in that figure, a backplane PCB segment may contain a plurality of connectors such as, for example, connectors 212, 214, 216, 218, and 219, for electronically coupling backplane PCB segment 200 to other devices. Connectors 212, 214, and 216 are depicted in FIG. 2A as being disposed on the rear side of backplane PCB segment 200 (indicated by their dashed outlines); by comparison, connectors 218 and 219 are depicted in the embodiment of FIG. 2A as being on the front side of backplane PCB segment 200.

Connectors 212 and 214 may be same-side backplane PCB connectors for electronically coupling backplane PCB segment 200 to other backplane PCB segments disposed adjacent to it. Connector 216 may be an opposite-side backplane PCB connector for electronically coupling backplane PCB segment 200 to other backplane PCB segments disposed across from backplane PCB segment 200 (rather than adjacent to it). Connector 218 may be a backplane-to-electronics-module connector, similar to PCB connectors 157 and 167, for electronically coupling backplane PCB segment 200 to an electronics module. Connector 219 may be an optical connector and is optionally included to provide optical coupling between backplane PCB segment 200 and, for example, an electronics module with an optical connector.

Connectors 212, 214, 216, and 218 may be high-speed connectors such as gigabit speed connectors. Connector 219, which may be an optical connector, may interface with the backplane PCB segment 200 using, for example, a gigabit interface convertor that translates optical signals received at connector 219 into electrical signals. Alternatively, backplane PCB segment 200 may include optical communications pathways.

Backplane PCB segment 200 may be composed of a plurality of layers. FIG. 2B depicts a stackup diagram of one possible configuration of layers. In the embodiment of FIG. 2B, exterior layers L1 and L6 may be used for mounting pads and low-speed signals, while interior layers L3 and L4 may be used for high-speed signals. Layer L2 may be used as a ground and layer L5 may be used for power. FIG. 2A depicts PCB layer interconnects 220, which may be used to create electronic communication paths between layers in backplane PCB segment 200.

Backplane PCB segment 200 may optionally include one or more active device chips 230. Active device chips may contain information regarding electronics modules that may be connected to backplane PCB segment 200. Based on the electronics modules that are connected, an active device chip 230 may, for example, dynamically switch or reroute signals within backplane PCB segment 200 to optimize for the identified electronics module. In this way, manual configuration of the backplane PCB may be avoided when new electronics modules are introduced to the system.

Backplane PCB segment 200 may also optionally include an ID chip 240. The ID chip 240 may be, for example, an electronically-erasable/programmable read-only memory that includes identification information for the backplane PCB segment 200. The identification information may be used for an inventory management system. For example, an inventory management system may track the IDs of which components have been deployed downhole and where they are deployed. Optionally, the ID chip may also store identification information for the electronics modules connected to backplane PCB segment 200. In one embodiment, information stored on an ID chip 240 may be accessed by means of downhole telemetry systems.

FIGS. 3A-C illustrate example embodiments of backplane PCBs for various configurations of a tool insert. FIG. 3A shows an embodiment where a tool insert 340 has four faces, similar to tool insert 110 from the embodiment of FIGS. 1A-B. By comparison, FIG. 3B shows an embodiment where a tool insert 330 has three faces, and FIG. 3C shows an embodiment where a tool insert 360 has six faces.

In each of the embodiments of FIGS. 3A-C, a backplane PCB may be provided comprised of one or more backplane PCB segments. In FIG. 3A, a backplane PCB 345 may be comprised of four backplane PCB segments 345a-d. Each of the backplane PCB segments 345a-d may be electronically coupled to its two neighboring backplane PCB segments by means of same-side backplane PCB connectors 346. For example, backplane PCB segment 345a is shown to be electronically coupled to backplane PCB segment 345b via same-side backplane PCB connectors 346. Each backplane PCB segment 345a-d may include an opposite-side backplane connector 347, for electrically coupling to opposite-side backplane PCBs, as well as a backplane-to-electronics-module connector 348.

Similarly, in the example embodiment of FIG. 3B, a backplane PCB 335 may be comprised of three backplane PCB segments 335a-c. Each of the backplane PCB segments 335a-c may be electronically coupled to the other two neighboring backplane PCB segments by means of same-side backplane PCB connectors 336. For example, backplane PCB segment 335a is shown to be electronically coupled to backplane PCB segment 335b via same-side backplane PCB connectors 336. Each backplane PCB segment 335a-c may include an opposite-side backplane connector 337, for electrically coupling to opposite-side backplane PCBs, as well as a backplane-to-electronics-module connector 338.

In the embodiments shown in FIGS. 3A-B, the number of backplane PCB segments was shown to be the same as the number of faces on the tool insert. By comparison, FIG. 3C illustrates an example embodiment with a six-faced tool insert 360 and a backplane PCB 365 comprised of two backplane PCB segments 365a-b. Backplane PCB segment 365a is shown to be electronically coupled to backplane PCB segment 365b by means of same-side backplane PCB connectors 366. Each backplane PCB segment 365a-b may include one or more opposite-side backplane PCB connectors 367, for electrically coupling to opposite-side backplane PCBs, as well as one or more backplane-to-electronics-module connectors 368.

Thus, tool inserts may come in a variety of configurations, such as the three-, four-, and six-faced configurations shown in FIGS. 3A-C, as well as other configurations such as, for example, circular cross-section tool inserts. As one of skill in the art will appreciate in light of the present disclosure, backplane PCBs may be adapted for those various configurations of tool inserts by use of one or more backplane PCB segments that may be electronically coupled to each other using same-side backplane PCB connectors. The use of multiple backplane PCB segments advantageously provides clamping action onto the tool insert. Further, each backplane PCB segment may contain one or more opposite-side backplane PCB connectors, for electrically coupling to opposite-side backplane PCBs, as well as one or more backplane-to-electronics-module connectors.

FIG. 4 shows an exploded view of an embodiment of a wire-harness-less assembly mechanism for a downhole tool assembly 400. The embodiment of FIG. 4 is similar to the embodiment of FIGS. 1A-B. For example, tool insert 410, base metal ring 440, insulators/dampers 442 and 449, backplane PCBs 455 and 465, and backplane-to-electronics-module connector 467 may be similar to tool insert 110, base metal ring 140, insulators/dampers 142 and 149, backplane PCBs 155 and 165, and backplane-to-electronics-module connectors 167, respectively. Additionally, same-side backplane PCB connectors 446 and opposite-side backplane PCB connectors 447 may be similar to the same-side backplane PCB connectors 346 and opposite-side backplane connectors 347 of FIG. 3A.

As shown in FIG. 4, a base metal ring 440 may include connector holes 445. Backplanes 455 and 465, disposed on opposite sides of the base metal ring 440, may be electronically coupled via opposite-side backplane connectors 447. Insulator/dampers 442 and 449 may be designed so as to accommodate opposite-side backplane connectors 447, for example by including cutouts aligned with connector holes 445.

FIG. 5 illustrates a cross-section of an example embodiment of a wire-harness-less assembly mechanism for a downhole tool assembly 500. The embodiment of FIG. 5 is similar to embodiment of FIGS. 1A-B. For example, tool insert 510, base metal ring 540, insulators/dampers 542 and 549, backplane PCBs 555 and 565, and backplane-to-electronics-module connector 557 and 567 may be similar to tool insert 110, base metal ring 140, insulators/dampers 142 and 149, backplane PCBs 155 and 165, and backplane-to-electronics-module connectors 157 and 167, respectively. Additionally, opposite-side backplane PCB connectors 547 may be similar to the opposite-side backplane connectors 347 of FIG. 3A.

FIG. 6A is a diagram of a subterranean drilling system 600. The drilling system 600 comprises a drilling platform 602 positioned at the surface 601. In the embodiment shown, the surface 601 comprises the top of a formation containing one or more rock strata or layers 618, and the drilling platform 602 may be in contact with the surface 601. In other embodiments, such as in an off-shore drilling operation, the surface 601 may be separated from the drilling platform 602 by a volume of water.

The drilling system 600 comprises a derrick 604 supported by the drilling platform 602 and having a traveling block 606 for raising and lowering a drill string 608. A kelly 610 may support the drill string 608 as it is lowered through a rotary table 612. A drill bit 614 may be coupled to the drill string 608 and driven by a downhole motor and/or rotation of the drill string 608 by the rotary table 612. As bit 614 rotates, it creates a borehole 616 that passes through one or more rock strata or layers 618. A pump 620 may circulate drilling fluid through a feed pipe 622 to kelly 610, downhole through the interior of drill string 608, through orifices in drill bit 614, back to the surface via the annulus around drill string 608, and into a retention pit 624. The drilling fluid transports cuttings from the borehole 616 into the pit 624 and aids in maintaining integrity or the borehole 616.

The drilling system 600 may comprise a bottom hole assembly (BHA) coupled to the drill string 608 near the drill bit 614. The BHA may comprise a LWD/MWD tool 626 and a telemetry element 628. In certain embodiments, the LWD/MWD tool 626 may be integrated at any point along the drill string 608. The LWD/MWD tool 626 may include receivers and/or transmitters (e.g., antennas capable of receiving and/or transmitting one or more electromagnetic signals). In some embodiments, the LWD/MWD tool 626 may include a transceiver array that functions as both a transmitter and a receiver. As the bit extends the borehole 616 through the formations 618, the LWD/MWD tool 626 may collect measurements relating to various formation properties as well as the tool orientation and position and various other drilling conditions. The orientation measurements may be performed using an azimuthal orientation indicator, which may include magnetometers, inclinometers, and/or accelerometers, though other sensor types such as gyroscopes may be used in some embodiments. In embodiments including an azimuthal orientation indicator, resistivity and/or dielectric constant measurements may be associated with a particular azimuthal orientation (e.g., by azimuthal binning). The telemetry sub 628 may transfer measurements from the LWD/MWD tool 626 to a surface receiver 630 and/or to receive commands from the surface receiver 630. Measurements taken at the LWD/MWD tool 626 may also be stored within the tool 626 for later retrieval when the LWD/MWD tool 626 is removed from the borehole 616.

In certain embodiments, the drilling system 600 may comprise an information handling system 632 positioned at the surface 601. The information handling system 632 may be communicably coupled to the surface receiver 630 and may receive measurements from the LWD/MWD tool 626 and/or transmit commands to the LWD/MWD tool 626 though the surface receiver 630. The information handling system 632 may also receive measurements from the LWD/MWD tool 626 when it is retrieved at the surface 601. In certain embodiments, the information handling system 632 may process the measurements to determine certain characteristics of the formation 603 (e.g., resistivity, permeability, conductivity, porosity, etc.) In some cases, the measurements and formation characteristics may be plotted, charted, or otherwise visualized at the information handling system 632 to allow drilling operators to alter the operation of the drilling system 600 to account for downhole conditions.

At various times during the drilling process, the drill string 608 may be removed from the borehole 616 as shown in FIG. 6B. Once the drill string 608 has been removed, measurement/logging operations can be conducted using a wireline tool 634, i.e., an instrument that is suspended into the borehole 616 by a cable 615 having conductors for transporting power to the tool and telemetry from the tool body to the surface 601. The wireline tool 634 may include one or more logging/measurement tools 636 having transmitters, receivers, and/or transceivers similar to those described above in relation to the LWD/MWD tool 626. The logging/measurement tool 636 may be communicatively coupled to the cable 615. A logging facility 644 (shown in FIG. 6B as a truck, although it may be any other structure) may collect measurements from the logging tool 636, and may include computing facilities (including, e.g., an information handling system) for controlling, processing, storing, and/or visualizing the measurements gathered by the logging tool 636. The computing facilities may be communicatively coupled to the logging/measurement tool 636 by way of the cable 615. In certain embodiments, the information handling system 632 may serve as the computing facilities of the logging facility 644. Embodiments of the wire-harness-less assembly mechanism according to the present disclosure may be incorporated, for example, into LWD/MWD tool 626 and/or wireline tool 634 to provide interconnection between electronics modules.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A downhole tool assembly, comprising:
a first electronics module and a second electronics module, wherein said first electronics module is communicatively coupled to said second electronics module via a backplane.

2. The downhole tool assembly of claim 1, wherein said backplane comprises a first printed circuit board and a second printed circuit board communicatively coupled to each other.

3. The downhole tool assembly of claim 2, further comprising a base metal ring disposed between said first printed circuited board and said second printed circuit board.

4. The downhole tool assembly of claim 3, wherein said first printed circuit board is communicatively coupled to said second printed circuit board via connector holes in said base metal ring.

5. The downhole tool assembly of claim 4, further comprising a damper between said base metal ring and one of said first printed circuit board and said second printed circuit board.

6. The downhole tool assembly of claim 1, wherein said backplane is comprised of a plurality of backplane segments.

7. The downhole tool assembly of claim 6, wherein at least one of said backplane segments includes an identification chip.

8. The downhole tool assembly of claim 6, wherein at least one of said backplane segments includes an active device chip.

9. The downhole tool assembly of claim 1, wherein said backplane is disposed proximate to a tool insert having one of the following cross sections: three faces, four faces, six faces, and circular.

10. A downhole tool assembly, comprising:
a tool insert;
a backplane coupled to said tool insert comprising a first printed circuit board and a second printed circuit board, wherein
said first printed circuit board comprises a first printed circuit board segment and a second printed circuit board segment, wherein said first printed circuit board segment is communicatively coupled to said second printed circuit board segment via a first same-side connector;
said second printed circuit board comprises a third printed circuit board segment and a fourth printed circuit board segment, wherein said third printed circuit board segment is communicatively coupled to said fourth printed circuit board segment via a second same-side connector;
a base metal ring disposed between said first printed circuit board and said second printed circuit board, wherein said first printed circuit board is communicatively coupled to said second printed circuit board through a connector hole in said base metal ring using an opposite-side connector;
a first damper disposed between said first printed circuit board and said base metal ring;
a second damper disposed between said base metal ring and said second printed circuit board; and
a first electronics module communicatively coupled to a second electronics module via said backplane.

11. A method for wire-harness-less assembly, comprising:
coupling a backplane to a tool insert;
providing connectors on said backplane for communicatively coupling said backplane to a first electronics module and a second electronics module.

12. The method of claim 11, wherein said backplane comprises a first printed circuit board and a second printed circuit board.

13. The method of claim 12, wherein said first printed circuit board is communicatively coupled to said second printed circuit board through connector holes in a base metal ring.

14. The method of claim 12, wherein said first printed circuit board and said second printed circuit board comprise a plurality of backplane segments.

15. The method of claim 11, further comprising providing an identification chip on said backplane.

16. The method of claim 11, further comprising providing an active device chip on said backplane.

17. A method for wire-harness-less assembly, comprising:
mounting a first electronics module and a second electronics module on a tool insert;
communicatively coupling said first electronics module and said second electronics module to a backplane.

18. The method of claim 17, further comprising
mounting a third electronics module on said tool insert;
communicatively coupling said third electronics module to said backplane; and
dynamically routing communicative signals to said third electronics module from at least one of said first electronics module and said second electronics module.

19. The method of claim 18, wherein dynamically routing communicative signals further comprises using information stored on an active device chip located on said backplane.

20. The method of claim 17, further comprising accessing information stored on an identification chip, wherein said identification chip is located on said backplane.
